(19) United States
(12) Patent Application Publication
(10) Pub. No.: US 2025/0371487 A1
(43) Pub. Date: Dec. 4, 2025

(54) Method and System for Supply Chain Data Optimization and Visualization

(71) Applicant: S&P Global Inc., New York, NY (US)

(72) Inventors: Robert Christie, Somerville, MD (US); Amy Chang, Richardson, TX (US); Emilee Nason, Somerville, MA (US); Vania Alvarez Murakami, Boston, MA (US); David Mottarella, Titusville, FL (US)

(21) Appl. No.: 18/677,379

(22) Filed: May 29, 2024

(51) Int. Cl. G06Q 10/0835; G06N 20/00; G06Q 10/0831

(52) U.S. Cl. CPC G06Q 10/08355; G06N 20/00; G06Q 10/0831

(57) ABSTRACT

A computer-implemented method for supply chain data optimization and visualization is provided. The method includes receiving training input and output data. The training input data comprises historical maritime and supply chain traffic data and the training output data comprises predicted supply chain routes. The method includes training a machine learning model using the training input and output data to generate a mapping function which maps the training input data to the training output data. The method includes generating an optimized supply chain route and at least one alternate supply chain route using selected parameters and the mapping function. The method includes displaying a visual representation of the optimized supply chain route and the alternate supply chain route.

### BACKGROUND INFORMATION

### 1. Field

The present disclosure relates generally to supply chain operation and management, and more specifically to a method and system for supply chain data optimization and visualization.

### 2. Background

Traditional approaches to supply chain operation and management have several limitations that impede their ability to fully address the complexities of modern supply chain operations. Many existing methods offer only a superficial understanding of supply chain information, lacking the depth needed to uncover hidden inefficiencies, bottlenecks, and optimization opportunities. Conventional techniques often rely on manual data analysis, which can be time-consuming, error-prone, and unable to handle the vast volumes of data generated by complex supply chains.

While some traditional systems offer descriptive analytics, they often lack predictive capabilities to anticipate future trends, risks, and opportunities, leaving decision-makers without the foresight needed to proactively address emerging challenges.

### SUMMARY

An illustrative embodiment provides a computer-implemented method for supply chain data optimization and visualization. The method includes receiving training input and output data. The training input data includes historical maritime and supply chain traffic data and the training output data includes predicted supply chain routes. The method includes training a machine learning model using the training input and output data and generating a mapping function which maps the training input data to the training output data. The method includes receiving on a user interface selected parameters. The method includes generating an optimized supply chain route and at least one alternate supply chain route using the selected parameters and the mapping function. The method includes displaying a visual representation of the optimized supply chain route and the alternate supply chain route.

In an illustrative embodiment, the training input data comprises at least one of: bill of lading data; maritime traffic and vessel data; and ship registry and voyage emission data. The selected parameters include one or more of: desired voyage time; desired geographic route; desired emissions; and climate and geographical risks associated with the desired geographic route.

In an illustrative embodiment, the method includes displaying information associated with the optimized supply chain route and the alternate supply chain routes. The information comprises one or more of cost, voyage time, voyage distance and emission associated with the supply chain routes.

In an illustrative embodiment, generating the optimized supply chain route comprises: determining a total voyage time, voyage distance and emission associated with the supply chain routes; determining climate and geographical risk events associated with the supply chain routes; comparing the supply chain routes; determining the supply chain route that minimizes the total voyage time, voyage distance, emission and circumvents the climate and geographical risks.

In an illustrative embodiment, a system for supply chain data optimization and visualization includes a storage device configured to store program instructions. The system includes a machine learning model configured to generate a mapping function which maps training input data to training output data. The system includes one or more processors operably connected to the storage device and the machine learning model. The processors are configured to execute the program instructions to cause the system to: receive the training input and output data, wherein the training input data is associated with historical maritime and supply chain traffic data and the training output data comprises predicted supply chain routes; train the machine learning model using the training and output data to generate the mapping function; receive selected parameters; and generate an optimized supply chain route and at least one alternate supply chain route using the selected parameters and the mapping function.

In an illustrative embodiment, a computer program product for supply chain data optimization and visualization includes a computer-readable storage medium having program instructions embodied thereon to perform the steps of: receiving, on a user interface, training input and output data, wherein the training input data comprises historical maritime and supply chain traffic data and the training output data comprises predicted supply chain routes; training a machine learning model using the training input and output data to generate a mapping function which maps the training input data to the training output data; receiving selected parameters; and generating an optimized supply chain route and at least one alternate supply chain route using the selected parameters and the mapping function.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 illustrates a network of a data processing system in accordance with an illustrative embodiment;

FIG. 2 is a block diagram of a system for supply chain data optimization and visualization in accordance with an illustrative embodiment;

FIG. 3 illustrates processes performed by components of a system in accordance with an illustrative embodiment;

FIG. 4 illustrates a flowchart of a process for a computer-implemented method for supply chain data optimization and visualization; and

FIG. 5 illustrates a block diagram of a data processing system in accordance with an illustrative embodiment.

### DETAILED DESCRIPTION

The illustrative embodiments address limitations of conventional supply chain operations. The illustrative embodiments provide a method and system for supply chain data optimization and visualization.

In an illustrative embodiment, a machine learning model is trained using training input and output data, and a mapping function is generated. The mapping function maps the training input data to the training output data. An optimized supply chain route and at least one alternate supply chain route in generated using selected parameters and the mapping function. The optimized supply chain route and the alternate supply chain route are displayed as a visual representation.

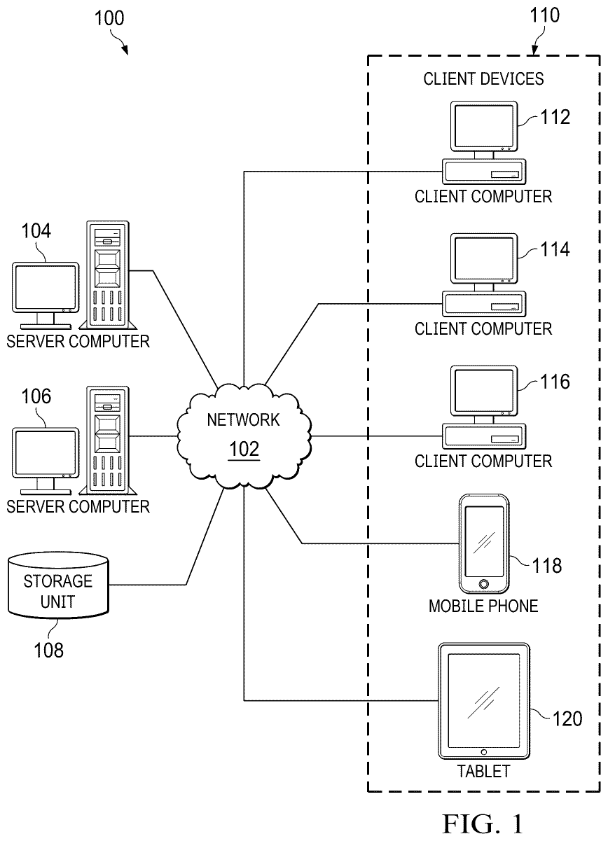

With reference to FIG. 1, a pictorial representation of a network of data processing system is depicted in which illustrative embodiments may be implemented. Network data processing system 100 is a network of computers in which the illustrative embodiments may be implemented. Network data processing system 100 contains network 102, which is the medium used to provide communications links between various devices and computers connected within network data processing system 100. Network 102 may include connections, such as wire, wireless communication links, or fiber optic cables.

In the depicted example, server computers 104 and 106 and storage unit 108 connect to network 102. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118 and tablet computer 120.

In the illustrative example of FIG. 1, server computers 104 and 106, storage unit 108, and client devices 110 are network devices that connect to network 102 in which network 102 is the communications media for these network devices.

Program code located in network data processing system 100 can be stored on a computer-recordable storage medium and downloaded to a data processing system or other device for use. For example, the program code can be stored on a computer-recordable storage medium on server computers 104 and 106 and storage unit 108 and downloaded to client devices 110 over network 102 for use on client devices 110.

In the illustrative example of FIG. 1, network 102 can be the Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Network data processing system 100 also may be implemented using different types of networks. For example, network 102 can be comprised an intranet, a local area network (LAN), a metropolitan area network (MAN), or a wide area network (WAN). FIG. 1 is intended as an example, and not as an architectural limitation for the different illustrative embodiments.

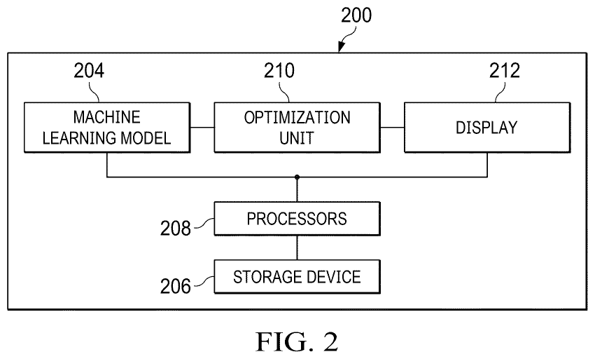

FIG. 2 is a block diagram of system 200 for supply chain data optimization and visualization in accordance with an illustrative embodiment. System 200 can be implemented, for example, in server computers 104 or in client devices 110. System 200 is a physical hardware system which includes one or more units or components that are in communication with each other.

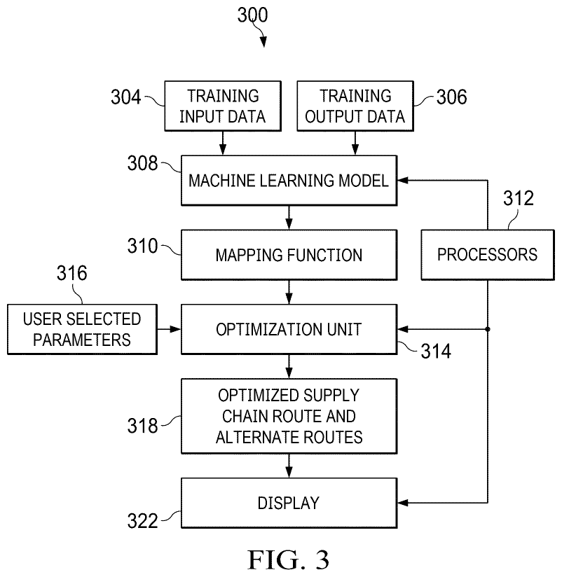

System 204 includes machine learning model 204, which is a mathematical representation or algorithm that learns patterns and relationships from data in order to make predictions, classifications or decisions. Machine learning model 204 is trained on a dataset that comprises input data (features) and corresponding output data (labels or targets). Machine learning model is further described with reference to FIG. 3.

System 200 includes storage device 206 which is a hardware component that stores data or instructions for later retrieval and use by system 200. Storage device 206 allows system 200 to store and access data quickly and efficiently, facilitating various computing tasks such as running programs, storing files, and maintaining system configurations. Storage device 206 can be, for example, a hard disk drive, a solid state drive, a RAM, a ROM, or a flash memory.

System 200 includes one or more processors 208 operably connected to machine learning model 204 and storage device 206. Processor 208 is configured to execute instructions and perform calculations necessary for the operation of system 200. Processor 208 controls flow of information between other components of system 200.

System 200 includes optimization unit 210 which improves the efficiency and effectiveness of supply chain operations. Optimization unit 210 is configured to analyze supply chain routes, identify areas for improvement, and generate an optimized supply chain route and alternate routes to enhance overall supply chain operation. Optimization unit 210 is further described in connection with FIG. 3.

System 200 includes display 212 which is also referred to as a monitor. Display 212 is connected to processor 208 and optimization unit 210. Display 212 can be a peripheral device used to visually display output from processor 208 and optimization unit 210. Display 212 serves as an interface between users and system 200. Display 212 allows users to view graphical information, text, images, videos, and other visual content generated by system 200.

FIG. 3 depicts processes performed by various components of system 300 for supply chain data optimization and visualization in accordance with an illustrative embodiment. In an illustrative embodiment, training input data 304 and corresponding training output data 306 are received by machine learning model 308. Training input data 304 may include one or more of historical and current maritime supply chain data, bill of lading data, ship registry data and voyage emission data. Historical data related to supply chain can be collected from various sources, including past shipping records, transportation routes, inventory levels, demand forecasts, supplier capabilities. This data provides insights into past transportation patterns, bottlenecks, and performance metrics. Training output data includes predicted supply chain routes which refer to the anticipated paths and sequences of transportation and distribution that goods and materials are expected to take within a supply chain network. These routes are forecasted based on historical data, predictive analytics, and optimization algorithms to minimize costs and meet customer demand effectively.

In an example embodiment, machine learning model 308 is a mathematical representation or algorithm that learns patterns and relationships between training input data 304 and corresponding training output data 306 in order to make predictions, classifications, or decisions. Machine learning model 308 learns from training input data 304 and training output data 305 to identify patterns and associations and generates mapping function 310 which maps training input data 304 to training output data 306.

System 300 includes one or more processors 312 operably connected to machine learning model 308. Processors 312 are configured to execute program instructions cause system 300 to perform various operations.

System 300 includes optimization unit 314 coupled to mapping function 310 and processors 312. Optimization unit 314 receives user selected parameters 316 which are specific criteria or preferences provided by users to optimization unit 314 to guide the generation of an optimized supply chain route and alternate routes 318. These parameters allow users to customize and tailor the supply chain routing solutions according to their unique requirements, objectives, and constraints. Example user selected parameters 316 can include cost thresholds, geographical preferences, capacity constraints and environmental considerations such as desired emission footprints. User selected parameters 316 may also include climate risks, geographical risks and geopolitical events.

Based on user selected parameters 316 and mapping function 310, optimization unit 314 identifies areas for improvement, and generates an optimized supply chain route and alternate routes 318 to enhance overall performance. The optimized supply chain route refers to the most efficient and effective path for transporting goods and materials within a supply chain network, as determined by optimization unit 314 based on user selected parameters 316 and mapping function 310. In addition to the optimized supply chain route, optimization unit 318 may also identify and generate alternate supply chain routes that provide additional flexibility, resilience, and risk mitigation capabilities. These alternate routes offer contingency options in case of disruptions, delays, or changes in operating conditions, allowing organizations to adapt and respond effectively to unforeseen events while maintaining supply chain performance.

In some embodiments, based on the optimized supply chain route and alternate route, supply chain orders may be generated. The supply chain orders may include requests or instructions within a supply chain network to procure, produce, transport or distribute goods. The supply chain orders serve as a mechanism to coordinate the flow of goods, information and resources across various stages of the supply chain.

System 300 includes display 322 which is also referred to as a monitor. Display 322 is connected to processor 312. Display 320 serves as an interface between users and system 300. Display 322 allows users to view graphical representations of the optimized supply chain route and the alternate supply chain routes.

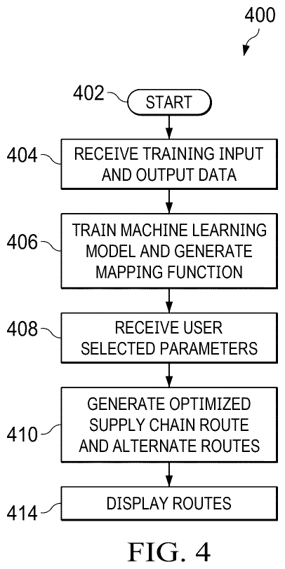

With reference next to FIG. 4, a flowchart of process 400 for a computer-implemented method for supply chain data optimization and visualization is provided.

Process 400 begins at step 402. Next, at step 404, training input data 304 and training output data 306 are received by machine learning model 308. In an example embodiment, training input data 304 includes one or more of historical and current maritime supply chain data, bill of lading data, ship registry data and voyage emission data. Historical data related to supply chain is collected from various sources, including past shipping records, transportation routes, inventory levels, demand forecasts, supplier capabilities. Training output data 306 includes predicted supply chain routes.

Next, at step 406, machine learning model 308 is trained using patterns and relationships between training input data 304 and corresponding training output data 306 in order to make predictions, classifications, or decisions. Machine learning model 308 generates mapping function 310 which maps between input data 304 (e.g., historical and current maritime supply chain data, bill of lading data, ship registry data and voyage emission data) and training output data 306 (e.g., predicted supply chain routes).

At step 408, user selected parameters 316 are received. These parameters allow users to customize and tailor the supply chain routing solutions according to their unique requirements, objectives, and constraints. Example user selected parameters 316 can include cost thresholds, geographical preferences, capacity constraints and environmental considerations such as desired emission footprints. User selected parameters 316 may also include climate risks and geographical risks.

At step 410, based on user selected parameters 316 and mapping function 310, optimization unit 314 identifies areas for improvement, and generates an optimized supply chain route and alternate routes 318 to enhance overall performance. The optimized supply chain route refers to the most efficient and effective path for transporting goods and materials within a supply chain network, as determined by optimization unit 314. In addition to the optimized supply chain route, optimization unit 318 may also identify and generate alternate supply chain routes that provide additional flexibility, resilience, and risk mitigation capabilities. These alternate routes offer contingency options in case of disruptions, delays, or changes in operating conditions, allowing organizations to adapt and respond effectively to unforeseen events while maintaining supply chain performance.

In some embodiments, based on the optimized supply chain route and alternate route, supply chain orders can be generated. The supply chain orders may include requests or instructions within a supply chain network to procure, produce, transport or distribute goods. The supply chain orders serve as a mechanism to coordinate the flow of goods, information and resources across various stages of the supply chain.

At step 414, the optimized supply chain route, the alternate supply chain routes and the supply chain orders are displayed on display 322. Information associated with the optimized supply chain route and the alternate supply chain routes are also displayed on display 320. The information may include cost, voyage time, voyage distance and emission associated with the supply chain routes.

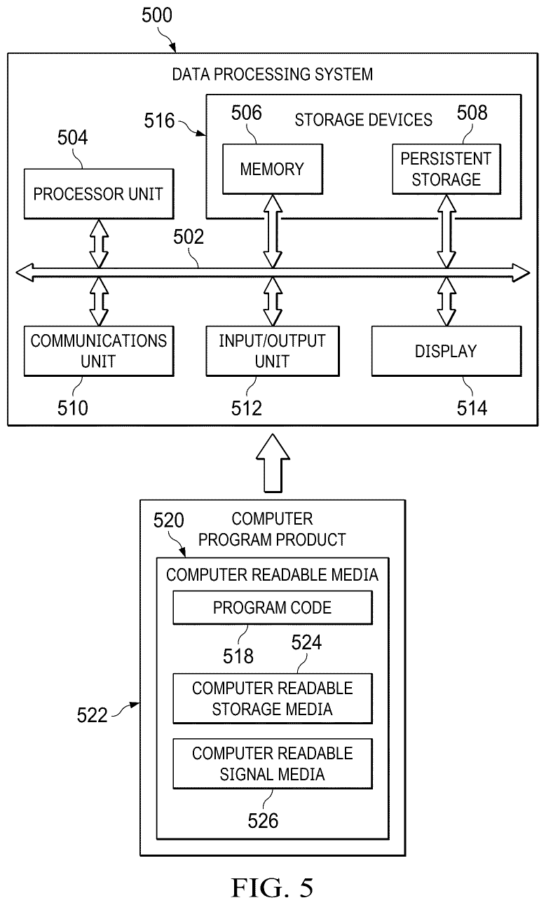

Turning now to FIG. 5, an illustration of a block diagram of a data processing system is depicted in accordance with an illustrative embodiment. Data processing system 500 may be used to implement server computers 104 and 106 and client devices 110 in FIG. 1, as well as computer system 200 in FIG. 2. In this illustrative example, data processing system 500 includes communications framework 502, which provides communications between processor unit 504, memory 506, persistent storage 508, communications unit 510, input/output unit 512, and display 514. In this example, communications framework 502 may take the form of a bus system.

Processor unit 504 serves to execute instructions for software that may be loaded into memory 506. Processor unit 504 may be a number of processors, a multi-processor core, or some other type of processor, depending on the particular implementation. In an embodiment, processor unit 504 comprises one or more conventional general-purpose central processing units (CPUs). In an alternate embodiment, processor unit 504 comprises one or more graphical processing units (GPUS).

Memory 506 and persistent storage 508 are examples of storage devices 516. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 516 may also be referred to as computer-readable storage devices in these illustrative examples. Memory 506, in these examples, may be, for example, a random access memory or any other suitable volatile or non-volatile storage device. Persistent storage 508 may take various forms, depending on the particular implementation.

For example, persistent storage 508 may contain one or more components or devices. For example, persistent storage 508 may be a hard drive, a flash memory, a rewritable optical disk, a rewritable magnetic tape, or some combination of the above. The media used by persistent storage 508 also may be removable. For example, a removable hard drive may be used for persistent storage 508. Communications unit 510, in these illustrative examples, provides for communications with other data processing systems or devices. In these illustrative examples, communications unit 510 is a network interface card.

Input/output unit 512 allows for input and output of data with other devices that may be connected to data processing system 500. For example, input/output unit 512 may provide a connection for user input through at least one of a keyboard, a mouse, or some other suitable input device. Further, input/output unit 512 may send output to a printer. Display 514 provides a mechanism to display information to a user.

Instructions for at least one of the operating system, applications, or programs may be located in storage devices 516, which are in communication with processor unit 504 through communications framework 502. The processes of the different embodiments may be performed by processor unit 504 using computer-implemented instructions, which may be located in a memory, such as memory 506. These instructions are referred to as program code, computer-usable program code, or computer-readable program code that may be read and executed by a processor in processor unit 504. The program code in the different embodiments may be embodied on different physical or computer-readable storage media, such as memory 506 or persistent storage 508.

Program code 518 is located in a functional form on computer-readable media 520 that is selectively removable and may be loaded onto or transferred to data processing system 500 for execution by processor unit 504. Program code 518 and computer-readable media 520 form computer program product 522 in these illustrative examples. In one example, computer-readable media 520 may be computer-readable storage media 524 or computer-readable signal media 526.

In these illustrative examples, computer-readable storage media 524 is a physical or tangible storage device used to store program code 518 rather than a medium that propagates or transmits program code 518. Computer readable storage media 524, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 518 may be transferred to data processing system 500 using computer-readable signal media 526. Computer-readable signal media 526 may be, for example, a propagated data signal containing program code 518.

The different components illustrated for data processing system 500 are not meant to provide architectural limitations to the manner in which different embodiments may be implemented. The different illustrative embodiments may be implemented in a data processing system including components in addition to or in place of those illustrated for data processing system 500. Other components shown in FIG. 5 can be varied from the illustrative examples shown. The different embodiments may be implemented using any hardware device or system capable of running program code 518.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A method for controlling an emission footprint of a shipment of goods, the method comprising:
receiving, on a user interface, training input data and training output data, wherein the training input data comprises historical maritime and supply chain traffic data and the training output data comprises predicted supply chain network routes, and wherein the historical maritime and supply chain traffic data includes: inventory levels, demand forecasts, and supplier capabilities;
training a machine learning model using the training input data and training output data and generating a mapping function which maps the training input data to the training output data;
receiving, on the user interface, selected parameters comprising a desired emission footprint for the shipment of the goods along supply chain network routes;
generating, using the selected parameters and the mapping function on the machine learning model, an optimized supply chain network route and at least one alternate supply chain network route that each produce the desired emission footprint;
displaying a visual representation of the optimized supply chain network route with emission information associated with the optimized supply chain network route; and
procuring, producing, transporting, or distributing, the goods for completing their transport with the desired emission footprint based on the optimized supply chain network route or the at least one alternate supply chain network route.

2. The method of claim 1, further comprising displaying a visual representation of the optimized supply chain network route and the at least one alternate supply chain network route.

3. The method of claim 1, wherein the training input data comprises at least one of:
bill of lading data;
maritime traffic and vessel data; and
ship registry and voyage emission data.

4. The method of claim 1, wherein the selected parameters include one or more of:
desired voyage time;
desired geographic route;
desired inventory levels;
desired emissions;
supply chain network constraints; and
climate and geographical risks associated with the desired geographic route.

5. The method of claim 1, further comprising displaying information associated with the optimized supply chain network route and the at least one alternate supply chain network route.

6. The method of claim 5, wherein the information comprises one or more of cost, voyage time, voyage distance and emission associated with the supply chain network routes.

7. The method of claim 1, wherein generating the optimized supply chain network route comprises:
determining totals for: a voyage time, a voyage distance, and an emission, associated with the supply chain network routes;
determining climate and geographical risk events and supply chain network constraints associated with the supply chain network routes;
comparing the supply chain network routes; and
determining the supply chain network route that minimizes the totals for: the voyage time, the voyage distance, and the emission, and circumvents the climate and geographical risks while meeting the supply chain network constraints.

8. A system configured to control an emission footprint of a shipment of goods, wherein the system comprises:
a storage device configured to store program instructions;
a machine learning model configured to generate a mapping function which maps training input data to training output data;
one or more processors operably connected to the storage device and the machine learning model and configured to execute the program instructions to cause the system to:
receive the training input data and training output data, wherein the training input data is associated with historical maritime and supply chain traffic data and the training output data comprises predicted supply chain network routes, and wherein the historical maritime and supply chain traffic data includes past shipping records, transportation routes, inventory levels, demand forecasts and supplier capabilities;
train the machine learning model using the training input data and training output data to generate the mapping function;
receive selected parameters that comprise a desired emission footprint for the shipment of goods along supply chain network routes;
generate, on the machine learning model, an optimized supply chain network route and at least one alternate supply chain network route that each produce the desired emission footprint;
display a visual representation of the optimized supply chain network route with emission information associated with the optimized supply chain network route; and
procure, produce, transport, or distribute, the goods that complete the shipment with the desired emission footprint based on the optimized supply chain network route or the at least one alternate supply chain network route.

9. The system of claim 8, wherein the processors are further configured execute instructions to cause the system to display a visual representation of the optimized supply chain network route and the at least one alternate supply chain network route.

10. The system of claim 8, wherein the training input data comprises at least one of:
bill of lading data;
maritime traffic and vessel data; and
ship registry and voyage emission data.

11. The system of claim 8, wherein the selected parameters include one or more of:
desired voyage time;
desired geographic route;
desired inventory levels;
desired emissions;
supply chain network constraints; and
climate and geographical risks associated with the desired geographic route.

12. The system of claim 8, wherein the processors further execute instructions to cause the system to display information associated with the optimized supply chain network route and the at least one alternate supply chain network route.

13. The system of claim 12, wherein the information comprises one or more of cost, voyage time, voyage distance and emission associated with the supply chain network routes.

14. The system of claim 8, wherein the processors further execute instructions to cause the system to generate the optimized supply chain network route by:
determining totals for: a voyage time, a voyage distance, and an emission, associated with the supply chain network routes;
determining climate and geographical risk events associated with the supply chain network routes;
comparing the supply chain network routes; and
determining the supply chain network route that minimizes the totals for: the voyage time, the voyage distance, and the emission, and circumvents the climate and geographical risks while meeting supply chain constraints.

15. A computer program product configured to control an emission footprint for a shipment of goods, wherein the computer program product comprises a computer-readable storage medium that comprises program instructions embodied thereon configured to:
receive, on a user interface, training input data and training output data, wherein the training input data comprises historical maritime and supply chain traffic data and the training output data comprises predicted supply chain network routes, and wherein the historical maritime and supply chain traffic data includes: inventory levels, demand forecasts, and supplier capabilities;
train a machine learning model using the training input data and the training output data to generate a mapping function which maps the training input data to the training output data;
receive selected parameters that comprise a desired emission footprint for the shipment along supply chain network routes;
generate, on the machine learning model, an optimized supply chain network route and at least one alternate supply chain network route that each produce the desired emission footprint;
display a visual representation of the optimized supply chain network route with emission information associated with the optimized supply chain network route; and
procure, produce, transport, or distribute, the goods that complete the shipment with the desired emission footprint based on the optimized supply chain network route or the at least one alternate supply chain network route.

16. The computer program product of claim 15, further comprising instructions configured to: display a visual representation of the optimized supply chain network route and the at least one alternate supply chain network route.

17. The computer program product of claim 15, wherein the training input data comprises at least one of:
bill of lading data;
maritime traffic and vessel data; and
ship registry and voyage emission data.

18. The computer program product of claim 15, wherein the selected parameters include one or more of:
desired voyage time;
desired geographic route;
desired inventory levels
desired emissions;
supply chain network constraints; and
climate and geographical risks associated with the desired geographic route.

19. The computer program product of claim 15, further comprising instructions for displaying information associated with the optimized supply chain network route and the at least one alternate supply chain network route.

20. The computer program product of claim 15, further comprising instructions for:
determining totals for: a voyage time, a voyage distance, and an emission, associated with the supply chain network routes;
determining climate and geographical risk events and supply chain network constraints associated with the supply chain network routes;
comparing the supply chain network routes; and
determining the supply chain network route that minimizes the totals for: the voyage time, the voyage distance, and the emission, and circumvents the climate and geographical risks while meeting the supply chain network constraints.
